(19) United States
(12) Patent Application Publication
(10) Pub. No.: US 2019/0246678 A1
(43) Pub. Date: Aug. 15, 2019

(54) Viscosity Reduction of Beverages and Foods Containing High Fiber Fruit and Vegetable Materials

(71) Applicant: Tropicana Products, Inc., Bradenton, FL (US)

(72) Inventors: Thomas BOILEAU, Libertyville, IL (US); Mary BRAUCHLA, Oak Park, IL (US); Rachel L. JORDAN, Palatine, IL (US); Prabhakar KASTURI, Barrington, IL (US); Rebecca REPLOGLE, Chicago, IL (US); Jin-E SHIN, Hoffman Estates, IL (US); Brian SONG, Schaumburg, IL (US)

(21) Appl. No.: 16/395,838

(22) Filed: Apr. 26, 2019

Related U.S. Application Data
(63) Continuation-in-part of application No. 15/247,411, filed on Aug. 25, 2016.
(60) Provisional application No. 62/378,953, filed on Aug. 24, 2016.

(51) Int. Cl. A23L 33/105; A23L 33/00

(52) U.S. Cl. CPC A23L 33/105; A23V 2002/00; A23L 33/30

(57) ABSTRACT

Enzymatically-treated pomace providing fiber for achieving a health benefit. Consumption, within a 24-hour period, of at least 5 grams of fiber from enzymatically-treated pomace achieves at least one health benefit. In one non-limiting embodiment, enzymatically-treated pomace provides a beverage with 2.5 grams of fiber per serving. A first serving of the beverage is consumed and a second serving of the beverage is consumed within 24 hours of the first serving to produce a reduction of blood glucose levels as compared to a baseline glucose level.

### CROSS REFERENCE TO RELATED APPLICATIONS

This application is a is a continuation-in-part of U.S. application Ser. No. 15/247,411, filed on Aug. 25, 2016, which claims the benefit of provisional U.S. Application No. 62/378,953 entitled “Viscosity Reduction of Beverages and Foods Containing High Fiber Fruit and Vegetable Materials” filed Aug. 24, 2016, provisional U.S. Application No. 62/346,077 entitled “Viscosity Reduction of Beverages and Foods Containing High Fiber Fruit and Vegetable Materials” filed Jun. 6, 2016, and provisional U.S. Application No. 62/210,261 entitled “Viscosity Reduction of Beverages and Foods Containing High Fiber Fruit and Vegetable Materials” filed Aug. 26, 2015, the technical disclosures of which are hereby incorporated by reference in their entirety.

### FIELD OF THE INVENTION

The present invention relates generally to beverage and food products containing enzymatically-treated high fiber fruit and vegetable materials, such as pomace. The beverage products exhibit a significantly reduced viscosity when compared to beverage products containing non-enzymatically-treated high fiber fruit and vegetable materials, and the fiber content of the high fiber fruit and vegetable materials remains the same pre and post enzymatic treatment.

### BACKGROUND

Fruit and vegetable-based products, especially juices and beverages, are popular among consumers as a healthy comestible and a means to meet their daily recommended amounts of fruits and vegetables. However, some food and vegetable-based products lack the nutrients contained in the whole fruit or vegetable. For example, due to the juice extraction process, portions of the whole fruit or vegetable, such as cellulosic materials, membranes, pulp, etc., are excluded from the juice that would otherwise be consumed if the fruit or vegetable were eaten whole.

Various attempts have been made to supplement fruit and vegetable juices to incorporate these lost nutrients back into the fruit and/or vegetable product. For instance, various fiber powders obtained from edible and/or typically inedible portions of foods are commercially available; however, such powders tend to impart an undesirable flavor to the juice. Moreover, they may dissolve so thoroughly that a consumer has difficulty believing that the juice does in fact contain the added fiber. Efforts to incorporate large pieces of insoluble fibers into juice have generally resulted in the inclusion of undesired color, flavor, and fibrous textures to the juice product. In addition, this takes longer time for hydration to be incorporated into juice or beverage. The thickness or viscosity of the juice, coupled with the appearance and mouthfeel associated with incorporating a substantial amount of the fibrous/solid materials into the product, pose the most problems from a consumer acceptability standpoint as well as a product processing standpoint.

The application of nutritious and fibrous components to finished products has been limited due primarily to the consumer's perception of the finished products containing the fibrous components as something other than juice (such as a smoothie or some other product containing a thick consistency).

Others in the industry have tried numerous methods to reduce the viscosity of beverages containing high-fiber fruit or vegetable materials. Exemplary methods include chemical hydrolysis and mechanical technologies. Although these methodologies reduce the viscosity of the high fiber fruit or vegetable materials, they are disadvantageous in the food and beverage industry for a variety of reasons. For instance, chemical hydrolysis subjects high fiber fruit or vegetable materials to chemicals, such as formic acid and hydrochloric acid, resulting in non-specific reactions whereby the chemicals react with glycosidic bonds in fiber and thus the fiber and sugar identities are not retained. Moreover, few food-grade chemicals are candidates for such use. A stigma is also attached to chemically-treated products as not being fresh or natural and such products may even be considered unhealthy.

Mechanical technologies to reduce the viscosity of the pomace, such as homogenization and micronization, cannot break down the fiber into a smaller chain size. Although the fibers may be pulverized or micronized, the chain length of the fibers remain intact, and thus, this method cannot deliver the same amount of fiber nor can it reduce viscosity of the fiber-containing pomace to the point where it is not detectable by the consumer.

### BRIEF SUMMARY

Aspects of the disclosure relate to a method for achieving a health benefit, which comprises consumption, within a 24-hour period, at least 5 grams of fiber from enzymatically-treated pomace to achieve the health benefit. In the embodiment where a total of 5 grams of fiber from enzymatically-treated pomace is consumed within a 24-hour period, the health benefit is at least one of a reduction of blood glucose levels as compared to a baseline blood glucose level and without a statistically significant increase in insulin level relative to a baseline insulin level.

In another embodiment where a total of 10 grams of fiber from enzymatically-treated pomace is consumed within a 24-hour period, the health benefit further comprises an increased frequency of bowel movements.

### BRIEF DESCRIPTION OF THE DRAWINGS

FIG. 1 is a flowchart depicting one aspect of the present disclosure, including steps taken in preparing of enzyme-treated pomace.

FIG. 2 is a graph depicting the effect of water activity of orange pomace based on added solutes.

### DETAILED DESCRIPTION

Some embodiments of the present disclosure is directed to a beverage product containing at least 1 wt % fiber in order to provide a high fiber beverage but with a low viscosity. As used herein, a low viscosity corresponds to a viscosity that is less than 250 cP at 20° C. In certain aspects of the invention, a significant amount of pomace may be used, for example 10 to 15 wt % or more of enzymatically-treated pomace. In some embodiments, the enzyme-treated pomace may be included in an amount between 1-40 wt %. For example, a beverage may be prepared having 25 wt % or more of the enzymatically-treated pomace. Another exemplary beverage product may be prepared with 36 wt % enzyme-treated pomace to form a beverage product with a high fiber content. “High fiber” or “high fiber content” as used in the present disclosure shall mean a fiber content of at least 1 wt %.

In other embodiments, the present disclosure describes a beverage product having at least 1 wt % fiber to provide a high fiber beverage with a high viscosity. As used herein, a high viscosity corresponds to a viscosity that is greater than 250 cP at 20° C. In these embodiments, the viscosity is also attributable to the presence of viscous ingredients, viscosity-building ingredients, and/or the amount of enzymatically-treated pomace included therein. For example, enzymatically-treated pomace in the range of 1-40 wt % may be added to viscous ingredients also in the range of 1-40 wt %, and more particularly between 20-40 wt % to create a beverage with a viscosity that is between 2000-4000 cP at 20° C.

It was discovered that fruit or vegetable pomace subjected to certain conditions and certain combinations of enzymes, exhibits no fiber loss, yet beverages containing the enzymatically-treated pomace may have a substantially lower viscosity than beverages containing non-enzymatically-treated pomace. As used herein, non-enzymatically-treated pomace may also be referred to as “untreated pomace.” These results were unexpected because although enzymatic hydrolysis is commonly used in the industry to reduce viscosity, such hydrolysis usually destroys the structure of the fiber and negatively impacts sensory attributes, including, for instance, cooked notes, of the product to which it is incorporated, and thus its nutritional value. Without being bound by theory, the inventors believe that under certain reaction conditions, a partial hydrolysis of the native_fiber contained in the pomace occurs, whereby the chain length of the native fiber-including pectin, hemicellulose and cellulose—is reduced, without reaching the point of complete hydrolysis (i.e., breaking down the fiber chain into sugar components). Chain length reduction occurs by endo-scission due to the presence of endo-acting enzymes. Moreover, chain length is reduced to an extent that fiber maintains its standard of identity as determined by the analytical fiber assays. The enzymatic treatment discussed herein was found to control molecular weight reduction. Although the molecular weight of the fiber changes following enzymatic treatment, both the pre and post treatment fiber can be classified as fiber. According to certain aspects of the disclosure, the beverage comprises pomace.

As used herein, the term “pomace” refers to the by-product remaining after fruit or vegetable juice pressing processes, wine crush operations, puree and concentrate operations, canning processes, and other food manufacturing processes. The pomace is typically discarded in the waste stream during processing. Pomace may include, for example, skins, peel, pulp, seeds, cellulosic material, and edible part of stems of the fruit and vegetable such as apples or carrots. Pomace generally contains more than a single item, for example, pomace may contain at least skin and pulp. In some cases the pomace can derive from or contain other parts of the fruit and vegetable such as pod, stalk, flower, root, leaves and tuber. Pomace resulting from juice extraction is typically in the form of a part of a press cake. Depending on the specific fruit or vegetable, pomace may contain portions of the fruit or vegetable which are inedible. Pomace differs from pulp. Pulp is the soft mass of fruit or vegetable matter from which most of the water has been extracted via pressure. For example, orange pomace includes membrane, but orange pulp does not. Further, apple pomace can contain skin, but apple pulp does not.

By-products from paste and puree processes such as tomato skins and seeds from tomato ketchup and paste processing are also included in the pomace even though they are not the by-products from juice extracts. Fruit skins from cannery processes are also edible by-products. Hereafter, pomace includes all by-products from fruit and vegetable juice, paste, puree and canning processes.

Wet pomace, which generally has a moisture content in the range between 70-85 wt %, generally contains high dietary fiber content, and varying amounts of essential vitamins, minerals and phytonutrients (depending on the types of fruit/vegetable and process applied). For example, cranberry pomace remains after the squeezing the juice for cranberry juices and concentrates. The pomace used in accordance with this invention may be derived from the same fruits and/or vegetables as the juice. In alternative embodiments, the pomace may be derived from fruits and/or vegetables that are different from the fruits and/or vegetables from which the juice is derived. In other embodiments the pomace is derived from fruits, vegetables or a combination of fruits and vegetables.

The pomace contains natural nutrients (such as Vitamin A, vitamin C, vitamin E, phytonutrients such as polyphenols and antioxidants), flavors, colors of the original fruits and vegetables and large amount of a natural (e.g., un-processed fibers. Most juice extraction by-product contains over 40% by weight (dry basis) of dietary fiber. The use of pomace in food products will fortify fiber and naturally existing nutrients such as vitamins and phytochemicals. The use of pomace will also enable the addition of fruit and vegetable fiber to foods which will fortify the food products with fiber and with naturally existing nutrients such as vitamins and phytochemicals.

In accordance with aspects of the invention, the pomace is enzymatically-treated. As used herein “enzymatically-treated” means adding an enzyme to the pomace to reduce the chain length of the fibrous material. The enzyme may be any enzyme that reduces the chain length of the targeted fiber to lower its molecular weight without releasing sugars. In this manner, the total fiber content of the starting pomace material prior to enzymatic treatment is maintained. In certain implementations, the enzyme used to treat the pomace may include pectinase, hemicellulase, cellulase, or any combination of the aforementioned enzymes. In one embodiment, the enzyme may be added to wet pomace in an amount of between 0.30 to 1 wt %, or between 0.15 to 1 wt %, but in some embodiments, an amount that is at least between 0.15 to 0.75 wt % of the pomace.

The enzymatic treatment takes place under certain conditions in order to achieve pomace that provides a substantial amount of fiber, yet provides a beverage product with a low viscosity. For instance, the mixture of wet pomace and enzyme may be heated, agitated, and/or mixed during enzymatic treatment. In one embodiment, the enzymes are combined with the pomace and the mixture of enzyme(s) and pomace is preheated to at least about 25° C., for example, to about 25-60° C. The mixture is then allowed to react at the heated temperature. The mixture may be agitated or mixed while preheating and/or during the reaction. In general, the enzyme/pomace mixture is allowed to react for about 10 minutes to about one hour. The reaction time and temperature are monitored and controlled to achieve this goal.

In aspects of the invention, the target viscosity is 60-250 cP in a juice or beverage measured at 20° C. with a Brookfield viscometer (spindle #1, 20 rpm) when the enzymatically-treated pomace is applied into juice or beverage. In aspects of the invention, the target viscosity is 25-150 cP in juice/beverage measured at 20° C. with a Brookfield viscometer (spindle #1, 20 rpm) when the enzymatically-treated pomace is applied into a reduced calorie beverage or a beverage having less than 100% juice. However, depending upon the type of reduced calorie beverage or beverage having less than 100% juice, the target viscosity may be the same as the full calorie beverage or beverage having 100% juice when mixed with enzymatically-treated pomace.

In one embodiment, the viscosity of a beverage incorporating the enzymatically-treated pomace is between 20-270 centipoise, and more specifically between 25-250 centipoise, when the enzymatically-treated pomace is included in an amount between 1-20 wt % of the beverage. In another embodiment, the viscosity of the beverage incorporating the enzymatically-treated pomace is between 230-1800 centipoise, and more specifically between 250 and 1780 centipoise, when the enzymatically-treated pomace is included in an amount between 20-40 wt % of the beverage. In yet another embodiment, the beverage comprises enzymatically-treated pomace in an amount between 1-40 wt %, with a corresponding viscosity between 1-1800 centipoise, and more specifically between 5-1780 centipoise. In some embodiments, these viscosities may correspond to the stated range of enzymatically-treated pomace regardless of whether the beverage is full calorie, reduced calorie, or whether the beverage is 100% juice or a juice drink that is less than 100% juice.

Following enzymatic treatment, the enzyme is deactivated. The enzyme may be deactivated using any method sufficient to deactivate the enzyme, including, without limitation, sterilization, pasteurization or otherwise subjecting the mixture to high temperature, short time (HTST) or ultra-high temperature (UHT) for a short time. For example, the enzyme is deactivated by heating to 75° C. to 107° C. for a period of time between 6 seconds to 600 seconds.

The enzymatically-treated pomace prepared in accordance with the present disclosure has the same fiber content as untreated pomace, but with shorter chain lengths. Thus, the overall fiber content is maintained during processing, as illustrated in Table 1, comparing the nutritional compositions of untreated pomace and enzyme-treated orange pomace.

TABLE 1

| | no-enzyme | enzyme | enzyme | enzyme |
|---|---|---|---|---|
| | treatment | treatment 1 | treatment 2 | treatment 3 |
| Fat (%) | 0.1 | 0.1 | 0.1 | 0.11 |
| Protein (%) | 1.16 | 1.25 | 1.3 | 1.35 |
| Total Sugars | 9 | 8.7 | 8.9 | 8.9 |
| (%) | | | | |
| Aarabinose (%) | 0.4 | 0.5 | 0.5 | 0.4 |
| Xylose (%) | BQL | BQL | BQL | BQL |
| Rhamnose (%) | BQL | BQL | BQL | BQL |
| Galactose (%) | BQL | BQL | BQL | BQL |
| Fructose (%) | 2.6 | 2.7 | 2.8 | 2.9 |
| Glucose (%) | 2.2 | 2.3 | 2.4 | 2.5 |
| Sucrose (%) | 4.2 | 3.7 | 3.7 | 3.5 |
| Maltose (%) | BQL | BQL | BQL | BQL |
| Lactose (%) | BQL | BQL | BQL | BQL |
| Total Dietary | 3.5 | 2.9 | 3.1 | 3 |
| Fiber (%) | | | | |
| Viscosity (cp) | 14620 | 3040 | 2120 | 2170 |
| Vitamin C | 24.07 | 24.38 | 23.64 | 21.38 |
| (mg/100 g) | | | | |

BQL: Below Quantification Limit

The enzymatically-treated pomace may then be added to a liquid to form a beverage product. Typically this is done at temperatures of between about 4° to 25° C. The beverage may be pasteurized before or after the addition of the enzymatically-treated pomace. The beverage product may undergo batch processing or continuous processing.

The liquid contained in the beverage product may be juice. The juice may be derived from any fruits, vegetables or a combination of fruits and vegetables. For instance, the juice may be derived from orange, pineapple, apple, mango, cranberry, grapefruit, blueberry, acai, strawberry, grape, passion fruit, tomato, cucumber, kale, spinach, broccoli, carrot, lemons limes, tangerine, mandarin orange, tangelo, pomelo, celery, beets, lettuce, spinach, cabbage, artichoke, broccoli, beet, Brussels sprouts, cauliflower, watercress, peas, beans lentils, asparagus, radish, peach, banana, pear, guava, apricot, watermelon, pomegranate, blackberry, papaya, lychee, plume, prune, fig or any combinations thereof. Moreover, the juice may be 100% juice or a juice drink that is less than 100% juice. The juice may be not-from-concentrate or from concentrate.

The liquid of the beverage product may also include water, such as coconut water or flavored water, nectars, serums, or carbonated water. In other embodiments, the liquid of the beverage product may be a dairy product such as milk or cream. The liquid may also be a combination of the above-mentioned liquids. For example, the liquid may be a mixture of both milk and juice, or juice and water.

In certain embodiments, the beverage product comprises between about 1-30 wt % of enzymatically-treated pomace, or between about 5-27 wt %, or between 10-15 wt % all based on total weight of the beverage product. In other embodiments, the beverage product includes between 1-20 wt % of the enzymatically-treated pomace, or between 20-40 wt % enzymatically-treated pomace. In a particular embodiment, the beverage product may include about 36 wt % of the enzymatically-treated pomace, and when in the absence of a viscous ingredient or a viscosity-building ingredient, such an amount would form a beverage product having a smoothie-like or spoonable consistency.

Beverage products containing the enzymatically-treated pomace exhibit a reduced viscosity compared to a beverage product that contains non-enzymatically-treated pomace. For instance, the viscosity in the beverage product containing the enzymatically-treated pomace may be at least 50% for example, up to about 90% less than the viscosity of a beverage product containing non-enzymatically-treated pomace. In additional embodiments, the viscosity is reduced anywhere in a range of about 50-90% compared to the same beverage product containing non-enzymatically-treated pomace. In certain aspects, the viscosity of the beverage products containing enzymatically-treated pomace is about 60-250 cP. In certain aspects the viscosity of the beverage product is about 100-150 cP. If the beverage is a low calorie beverage or one that does not contain 100% juice, then the viscosity can be as low as 25 cp, e.g. 25 to 150 cp. The viscosity measurements discussed herein were taken with a Brookfield viscometer at 20 rpm with spindle #1 at 20° C. In other aspects, the viscosity of the beverage product incorporating enzymatically-treated pomace may vary based upon the amount of the enzymatically-treated pomace that is added.

Various additional components may be added to the beverage product in aspects of this disclosure. These components may include, without limitation, flavors, flavorings, sweeteners, food-grade acidulants, such as citric acid, vitamins and minerals, grains, and proteins. Non-limiting examples of grains may include rice, wheat, and oats. Sweeteners may be nutritive and/or non-nutritive. In alternative aspects of the disclosure, carbon dioxide can be used to provide effervescence to the beverages. Any of the techniques and carbonating equipment known in the art for carbonating beverages can be employed. Typical embodiments may have, for instance, from about 0.5 to 5.0 volumes of carbon dioxide.

As previously mentioned, other components may take the form of viscous ingredients such as fruit and/or vegetable purees, and viscosity-building ingredients, such as cereal flour, carrageenan, pectin, gellan gum, etc. These ingredients may be included in a beverage to create a beverage product having a thicker, smoothie-like or spoonable consistency. The utilization of enzymatically-treated pomace in these thicker, more viscous beverage products enables the creation of a beverage that has a higher amount of fiber, but without further increasing the viscosity to levels that may be unexpected or undesirable for consumers. As used herein, these high viscosity beverage products may also referred to herein as “spoonable”.

The beverage product may be full calorie, reduced calorie, or low calorie. As used herein, “reduced calorie beverage” means a beverage having at least a 25% reduction in calories per 8 oz. serving of beverage as compared to the full calorie version, typically a previously commercialized full-calorie version. As used herein, a “low-calorie beverage” has fewer than 40 calories per 8 oz. serving of beverage. The correlative meaning applies to beverage concentrates and other beverage products disclosed here. In certain exemplary embodiments, the reduced calorie beverage may be low calorie beverage. The reduced calorie beverage may be sweetened entirely with one or more non-nutritive sweeteners or with a combination of nutritive and non-nutritive sweeteners.

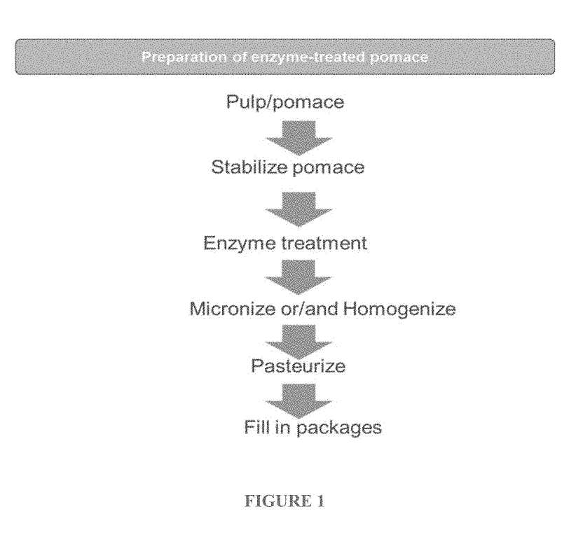

FIG. 1 is a method for creating enzymatically-treated pomace in accordance with an illustrative embodiment. As illustrated in FIG. 1, in an aspect of the present disclosure, the pulp/pomace is obtained, then stabilized by treating with heat (preheating). The preheated pomace is subsequently subjected to enzyme treatment. In one embodiment, the enzyme treatment step involves combining the enzymes with the pomace to form an enzyme-pomace mixture, which is then heated to at least about 25° C., for example, to about 25-60° C. The mixture may be agitated or mixed during the reaction, which may last between 10-60 minutes. After the enzyme treatment step, the enzyme is deactivated, for example, by heating the mixture to 75° C. to 107° C. for 6-600 seconds. The particle size of the enzymatically-treated pomace may be reduced via micronization, homogenization, or a combination of these processes. The enzymatically-treated pomace is then added to a fruit and/or vegetable juice, pasteurized and filled in packages. Pasteurization may take place under standard conditions, such as HTST.

In addition to the benefits, including viscosity reduction and fiber retention, the mouthfeel of the beverage products according to non-limiting embodiments described herein is acceptable to consumers. In particular, juices containing untreated pomace tend to have a higher viscosity and a thicker mouthfeel, i.e., more like a smoothie than a pulp-free juice. Testing was performed to identify what range of orange juice viscosities is most acceptable to consumers. Based on this testing, the inventors found that consumers preferred the thinnest product, i.e., the product with the lowest viscosity. Moreover, with respect to juices and acceptability, consumers prefer a juice that is not much thicker than a regular orange juice. The inventors also found that as long as the product was not too thick, consumer who prefers “no-pulp” products are willing to accept some viscosity for a more nutritious product.

Table 2 illustrates responses relating to consumer liking and mouthfeel for 100% orange juice containing various viscosity and pulp density measurements (beverages that did not contain floating pulp have a density of 0. The letters a, b, c, d, e, and f are used herein to denote significant differences at p=0.10). In accordance with conventional use, if two numbers share the same letter, they are not significantly different from each other. If they do not share a common letter, then they are significantly different from each other. For example, if a number is labelled “a”, then it is significantly different than numbers labelled with b, c, d, e, or f as well as numbers labeled with bcd or edf or bc, but it is not significantly different from other numbers labelled with an “a” such as abc or adf or abd or abdf.

TABLE 2

| | All Participants (n = 206) | | | | | | | | | | |
|---|---|---|---|---|---|---|---|---|---|---|---|
| | 100% OJ | 100% OJ | 100% OJ | 100% OJ | 100% OJ | 100% OJ | 100% OJ | 100% OJ | 100% OJ | 100% OJ | 100% OJ |
| | (Viscosity | (Viscosity | (Viscosity | (Viscosity | (Viscosity | (Viscosity | (Viscosity | (Viscosity | (Viscosity | (Viscosity | (Viscosity |
| 100% OJ | 20 | 85 | 100 | 150 | 20 | 85 | 150 | 20 | 85 | 100 | 150 |
| Viscosity | Density | Density | Density | Density | Density | Density | Density | Density | Density | Density | Density |
| Density | 0) | 0) | 0) | 0) | 15) | 15) | 15) | 30) | 30 | 30) | 30) |
| Overall | 306.9 a | 301.3 | 288.5 | 287.3 | 293.6 | 284.6 b | 291.1 | 283.1 b | 286.1 b | 283.1 b | 285.2 b |
| Appearance | | ab | ab | ab | ab | | ab | | | | |
| Liking | | | | | | | | | | | |
| Color | 314.7 | 309.5 | 307.4 | 302.6 | 312.5 | 301.1 | 308.6 | 306.4 | 304.6 | 301.2 | 304.3 |
| Liking | | | | | | | | | | | |
| Mouthfeel | 292.3 a | 266.8 | 238.7 | 217.0 f | 268.0 | 254.6 | 239.1 | 274.9 | 254.5 | 244.5 | 233.8 |
| Liking | | abcd | def | | abc | bcde | def | ab | bcde | cdef | ef |
| Thickness | 271.6 a | 256.6 | 231.2 | 202.3 f | 265.6 | 243.5 | 226.9 | 261.6 | 250.5 | 237.7 | 221.5 |
| Liking | | abc | cde | | ab | abcde | def | ab | abcd | bcde | ef |
| Bits of | 221.7 | 221.7 | 198.8 b | 199.6 b | 243.2 a | 232.0 | 224.5 | 246.1 a | 239.8 a | 237.8 a | 230.5 |
| Orange | ab | ab | | | | ab | ab | | | | ab |
| Liking | (n = 85) | (n = 101) | (n = 107) | (n = 110) | (n = 180) | (n = 186) | (n = 183) | (n = 194) | (n = 185) | (n = 195) | (n = 195) |
| (Removed | | | | | | | | | | | |
| Non- | | | | | | | | | | | |
| Detectors) | | | | | | | | | | | |
| Bits of | 137.6 d | 140.4 d | 133.6 d | 137.0 d | 184.4 c | 201.6 | 184.6 c | 213.3 | 218.3 | 211.6 | 226.7 a |
| Orange | | | | | | bc | | ab | ab | ab | |
| Amount | (n = 87) | (n = 101) | (n = 106) | (n = 100) | (n = 183) | (n = 184) | (n = 185) | (n = 194) | (n = 189) | (n = 193) | (n = 191) |
| (Removed | | | | | | | | | | | |
| Non- | | | | | | | | | | | |
| Detectors) | | | | | | | | | | | |
| Aftertaste | 262.9 a | 251.3 | 226.3 | 215.1 c | 255.3 a | 246.3 | 238.3 | 265.8 a | 255.7 a | 244.9 | 240.0 |
| Liking | | ab | bc | | | ab | abc | | | ab | abc |

In addition to providing desirable mouthfeel, the inclusion of enzyme-treated pomace has been shown to provide beverage products with an improved taste profile, particularly in the presence of beverage ingredients that may cause the taste to differ from a beverage product that utilizes all-natural ingredients, or only 100% juice ingredients. For example, low calorie beverages sweetened in whole or in part by a non-nutritive sweetener typically have a distinctive taste. The inclusion of enzyme-treated pomace to a low-calorie beverage in the amount between 1-40 wt % has been shown to mask the taste attributable to the non-nutritive sweetener. As a result, the low-calorie beverage has a more natural taste.

### Example 1

Orange pomace is enzymatically-treated by adding about 0.15 to 1 wt % of an enzyme mixture containing pectinase alone or in combination with hemicellulase and/or cellulase based on wt % of fiber in orange pomace and heating to at least about 25° C. The enzymatically-treated pomace can be micronized/homogenized for consistency of ingredients and deactivated.

The enzymatically-treated pomace is added to a food-safe liquid, for example, 100% not-from concentration (NFC) orange juice in the amounts identified in Table 3 below. The mixture is agitated for 10 minutes. The resulting fiber content (wt % based on total weight of the pomace) and viscosity values of the resulting beverage product are included in Table 3. From the data included in Table 3, a beverage can be formulated with enzymatically-treated pomace in an amount between 1-40 wt % of the beverage, with a corresponding viscosity between 1-1800 centipoise, and more specifically between 5-1780 centipoise. At higher viscosities, the beverage has a smoothie-like consistency. For example, with enzymatically-treated pomace in an amount of around 36 wt %, the beverage has a viscosity between 1300-1500 centipoise, and more specifically about 1400 centipoise.

TABLE 3

| Ingredient | NFC OJ with enzyme treated pomace | | | | | | | |
|---|---|---|---|---|---|---|---|---|
| NFC OJ (%) | 95.7 | 88.3 | 85 | 85 | 75 | 70 | 64 | 60 |
| Orange | 4.3 | 11.7 | 15 | 21.7 | 25 | 30 | 36 | 40 |
| Pomace (%) | | | | | | | | |
| Fiber (%) | 0.5 | 0.85 | 1 | 1.32 | 1.475 | 1.7 | 2 | 2.18 |
| Viscosity | 32 | 80 | 100 | 278 | 714* | 956* | 1400* | 1776* |
| (cP) | | | | | | | | |

Viscosity values identified with a single asterisk (*) were measured with spindle #2 of a Brookfield viscometer. The remaining values were measured with spindle #1. All samples were measured at 20 RPM and 20 degrees C.

In contrast, NFC orange juice combined with the same pomace that was not enzymatically-treated contained the same amount of fiber as the beverage product containing enzymatically-treated pomace; however, the viscosity of the beverage product containing the enzymatically-treated pomace was significantly lower than the beverage product containing non-enzymatically-treated pomace. Results of the non-enzymatically-treated orange juice are provided in Table 4 for comparison.

TABLE 4

| Ingredient | NFC OJ with untreated pomace | | | | | | | |
|---|---|---|---|---|---|---|---|---|
| NFC OJ | 95.7 | 88.3 | 85 | 85 | 75 | 70 | 64 | 60 |
| (%) | | | | | | | | |
| Orange | 4.3 | 11.7 | 15 | 21.7 | 25 | 30 | 36 | 40 |
| Pomace (%) | | | | | | | | |
| Fiber (%) | 0.5 | 0.85 | 1 | 1.32 | 1.475 | 1.7 | 2 | 2.18 |
| Viscosity | 55 | 265 | 463 | 1300* | 1340* | 2140** | 3880** | 5400** |
| (cP) | | | | | | | | |

Viscosity values identified with a single asterisk (*) were measured with spindle #2 of Brookfield. Those marked with a double asterisk (**) were measured with spindle #5. All remaining values were measured with spindle #1.

### Example 2

Orange pomace is enzymatically-treated by adding about 0.15 to 1 wt % of an enzyme mixture containing pectinase alone or in combination with hemicellulase and/or cellulase based on wt % of fiber in orange pomace and heating to at least about 25° C. The enzymatically-treated pomace can be micronized/homogenized for consistency of ingredients and deactivated.

The enzymatically-treated pomace is combined with puree and juice to form a spoonable beverage product having a viscosity that is greater than 3000 cP, as measured by a Brookfield rotary viscometer at 20° C. More specifically, between 30-40 wt % of the pomace is added to an equal amount of fruit and/or vegetable puree, the remainder of the beverage product formed from a fruit and/or vegetable juice to create a beverage product having a viscosity that is greater than 3000 cP, and more particularly between 3000-4000 cP. Even more specifically, 35.98 wt % orange pomace is added with an equal amount of mango puree, and 29.98 wt % apple juice, as shown in Table 5 below, to create a beverage product having a viscosity of 3425 cP.

TABLE 5
SPOONABLE FORMULATION #1

| Ingredients | Weight % |
|---|---|
| Orange Pomace | 35.98 |
| Mango Puree | 35.98 |
| Apple Juice | 29.98 |
| Mango Citrus Flavor | 0.05 |
| Total (%) | 100.00 |
| Viscosity | 3425 cP |

### Example 3

Orange pomace is enzymatically-treated by adding about 0.15 to 1 wt % of an enzyme mixture containing pectinase alone or in combination with hemicellulase and/or cellulase based on wt % of fiber in orange pomace and heating to at least about 25° C. The enzymatically-treated pomace can be micronized/homogenized for consistency of ingredients and deactivated.

In this illustrative example, the pomace is combined with puree and juice, and a viscosity-building ingredient to create a spoonable beverage product having a viscosity that is greater than 2000 cP, as measured by a Brookfield rotary viscometer at 20° C. More specifically, between 10-20 wt % of pomace may be added to a fruit and/or vegetable puree in an amount between 30-40 wt %, including an amount of a viscosity-building ingredient that ranges between 1-5 wt %. Juice is also added in an amount between 40-54 wt %, yielding a beverage having a viscosity that is between 2000-3000 cP. In a more specific example, as shown in Table 6, about 15 wt % orange pomace is added to about 22 wt % carrot puree and about 12 wt % apple puree. The beverage product also includes about 12 wt % apple juice and about 35 wt % orange juice, and about 3.2 wt % oat flour. About 0.05 wt % of citric acid is also added. The beverage product has a viscosity that is about 2510 cP, as measured by a Brookfield rotary viscometer at 20° C.

TABLE 6
SPOONABLE FORMULATION #2

| Ingredients | Weight % |
|---|---|
| Orange Pomace | 14.99 |
| Carrot Puree | 21.99 |
| Apple Puree | 12.39 |
| Apple Juice | 12.39 |
| Oat Flour | 3.2 |
| Orange Juice | 34.98 |
| Citric Acid | 0.05 |
| Total (%) | 100.00 |
| Viscosity | 2510 cP |

Carrageenan is a commonly used viscosity-building ingredient or gelling agent that is extracted from red edible seaweeds. Carrageenan may be added to a beverage product to cause gelling, which increases the viscosity of the beverage to which it is added. In the two examples that follow, varying amounts of carrageenan have been added to a beverage product that also includes enzymatically-treated pomace.

### Example 4

Orange pomace is enzymatically-treated by adding about 0.15 to 1 wt % of an enzyme mixture containing pectinase alone or in combination with hemicellulase and/or cellulase based on wt % of fiber in orange pomace and heating to at least about 25° C. The enzymatically-treated pomace can be micronized/homogenized for consistency of ingredients and deactivated. The pomace, a viscous ingredient, and a viscosity-building ingredient are mixed with water and some other flavorants. More specifically, between 30-40 wt % of orange pomace is combined with 10-20 wt % of a viscosity-building ingredient, such as carrageenan, and 1-5 wt % orange concentrate. Between 7-17 wt % water is added, along with flavorants. In a more specific example, as shown in Table 7, about 35 wt % orange pomace is mixed with about 15 wt % carrageenan, 3.2 wt % orange concentrate, and about 12.4 wt % water. The remaining ingredients include sodium citrate, sugar, and flavor.

TABLE 7
SPOONABLE FORMULATION #3

| Ingredients | Weight % |
|---|---|
| Carrageenan | 14.99 |
| Sodium Citrate | 21.99 |
| Sugar | 12.39 |
| Water | 12.39 |
| Orange Concentrate | 3.2 |
| Orange Pomace | 34.98 |
| Flavor | 0.05 |
| Total (%) | 100.00 |

### Example 5

Orange pomace is enzymatically-treated by adding about 0.15 to 1 wt % of an enzyme mixture containing pectinase alone or in combination with hemicellulase and/or cellulase based on wt % of fiber in orange pomace and heating to at least about 25° C. The enzymatically-treated pomace can be micronized/homogenized for consistency of ingredients and deactivated.

The enzymatically-treated pomace is combined with viscous ingredients, viscosity-building ingredients, flavorants, and water to form spoonable beverage product. More specifically, between 10-20 wt % of the pomace mixed with 20-30 wt % viscous ingredients, which may include yogurt, blueberry puree, and black currant concentrate. Also mixed with the pomace are viscosity-building ingredients, such as carrageenan and oat flour, in an amount between 1-5 wt %. About 40-60 wt % liquids, such as water and juice, along with 2-10 wt % flavorants and citric acid. A more specific example of the formulation is provided in Table 8 below.

TABLE 8
SPOONABLE FORMULATION #4

| Ingredients | Weight % |
|---|---|
| Carrageenan | 0.35 |
| Sodium Citrate | 0.2 |
| Sugar | 5 |
| Water | 43.035 |
| Oat Flour | 3.2 |
| FC Orange Juice | 6.9 |
| Orange Pomace | 15 |
| Citric Acid | 0.1 |
| Yogurt | 22.4 |
| Blueberry Puree | 3.165 |
| Black Currant Concentrate | 0.5 |
| Mixed Berry Flavor | 0.15 |
| Total (%) | 100.00 |

### Example 6

Orange pomace is enzymatically-treated by adding about 0.15 to 1 wt % of an enzyme mixture containing pectinase alone or in combination with hemicellulase and/or cellulase based on wt % of fiber in orange pomace and heating to at least about 25° C. The enzymatically-treated pomace can be micronized/homogenized for consistency of ingredients and deactivated.

The orange pomace is mixed with a liquid formed from a mixture of milk and juice, a viscosity-building ingredient, edible acids, and flavorants to create a beverage product with a viscosity greater than 300 cP. More specifically, between 10-20 wt % orange pomace is added to 75-85 wt % of a liquid mixture formed from milk and juice to form a beverage product with a viscosity between 300-400 cP. Between 1-5 wt % oat flour is added, along with between 0.1-0.04 wt % edible acid, and between 0.1-0.5 wt % flavorant. A more specific example is provided in Table 8 below, which has a viscosity of about 350 cP.

TABLE 8
JUICE AND DAIRY FORMULATION

| Ingredients | Weight % |
|---|---|
| Skim Milk | 21 |
| Orange Juice | 60 |
| Orange Pomace | 15 |
| Oat Flour | 3.4 |
| Malic Acid | 0.16 |
| Citric Acid | 0.13 |
| Orange Flavor | 0.31 |
| Total | 100 |
| Viscosity | 350 cP |

By maintaining the amount of fiber throughout processing, fiber-related health claims may be made with respect to the beverage products containing the enzymatically-treated pomace.

Enzymatically-treated pomace may be combined with fruit juices or fruit juice concentrates for water activity reduction. This combination of pomace and fruit juice enables the addition of concentrated fruit or vegetable products to foods. This addition of whole fruit and vegetable products to shelf stable foods increases the nutritional value of the food as previously described for beverage products.

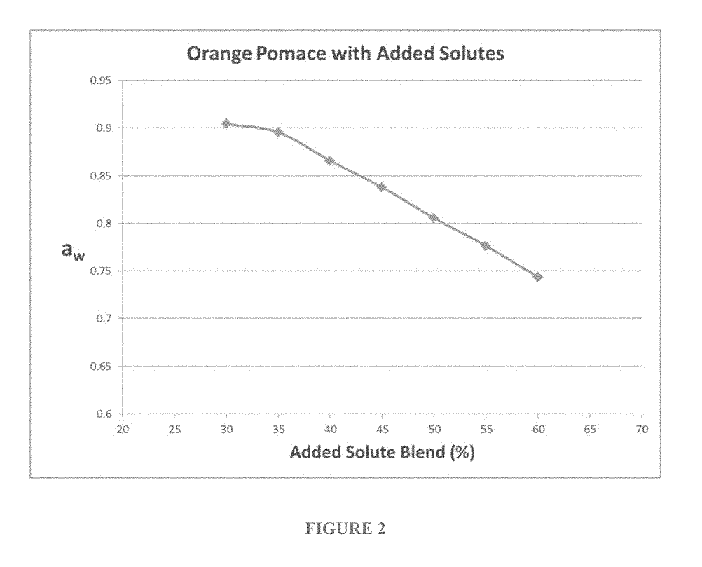

Food products may also be produced with enzyme treated high fiber fruit and vegetable materials, such as pomace. In food products, enzymatically-treated pomace, prepared in accordance with aspects of this disclosure, can be combined with soluble solids such as sugars, sugar alcohols and salts to reduce the water activity of the pomace. For example, the starting water activity of the orange pomace is 0.987. The ending water activity can be adjusted to a desired water activity which depends on the amount of solutes added. For microstability, with the use of potassium sorbate, it is desired to reduce the water activity to below 0.83. See Table 9 below and FIG. 2.

TABLE 9
Effect on Water Activity of a Model Solute Blend

| | % | % | % | % | % | % | % | % |
|---|---|---|---|---|---|---|---|---|
| Orange Pomace | 0.00 | 70.0 | 65.00 | 60.00 | 55.00 | 50.00 | 45.00 | 40.00 |
| Solute Blend | | | | | | | | |
| Glycerine, 99% USP | 56.67 | 16.71 | 19.48 | 22.27 | 25.04 | 27.83 | 30.63 | 33.40 |
| Fructose, crystalline | 19.08 | 5.72 | 6.68 | 7.63 | 8.59 | 9.54 | 10.49 | 11.45 |
| Honey | 19.08 | 5.72 | 6.68 | 7.63 | 8.59 | 9.54 | 10.49 | 11.45 |
| Milk permeate powder | 6.17 | 1.85 | 2.16 | 2.47 | 2.78 | 3.09 | 3.39 | 3.70 |
| Solute Blend Total (%) | 100.00 | 30.00 | 35.00 | 40.00 | 45.00 | 50.00 | 55.00 | 60.00 |
| Total % | 100.00 | 100.00 | 100.00 | 100.00 | 100.00 | 100.00 | 100.00 | 100.00 |
| Water Activity | | 0.904 | 0.896 | 0.866 | 0.838 | 0.805 | 0.776 | 0.743 |

This reduced water activity pomace may be incorporating as a filling, topping, binder or inclusion in shelf-stable food products. In addition, water activity reduced pomace may be formulated as a dip, spread, or topping that can be used for dipping, spreading or topping on fruits, vegetables, breads, crackers or chips. For food products, the viscosity reduction of pomace facilitates processing.

For example, pomace may be dehydrated using either heat to remove moisture or heat and vacuum to remove moisture under lower temperature conditions. This dehydration of pomace is facilitated by the viscosity reduction of the enzymatically-treated pomace. Generally, in dehydration processes, the maximum dehydration is limited by the increase in viscosity corresponding to the increase in solids content. Enzyme treated pomace allows for a greater concentration of the pomace (greater solids concentration and corresponding lower moisture content) to be incorporated into a food product. Further, with the lower moisture content of the pomace of the present disclosure, greater water activity reduction can be achieved. This water activity reduction is important for imparting microbiological shelf stability of the food products. In addition, as the pomace is concentrated, less soluble solids are required for lowering the water activity, which allows an equivalent water activity reduction with the addition of less sugars, sugar alcohols and salts.

### Example 7

An orange pomace filling is made by combining orange pomace with filling ingredients. The water activity of this orange pomace filling is 0.77.

Orange Pomace Filling

| Ingredients | Formula (%) |
|---|---|
| Orange Pomace | 33.30 |
| Potassium Sorbate | 0.09 |
| Glycerine, 99%, USP | 9.04 |
| Dextrose (Glucose) | 14.28 |
| Fructose, crystalline | 14.15 |
| Invert Sugar Syrup | 12.39 |
| Sugar (sucrose), bulk fine | 10.53 |
| Starch, Mira-thik 468 | 0.94 |
| Starch, Mira-gel 463 | 0.94 |
| Starch, Lo-temp 588 | 1.51 |
| Microcrystalline Cellulose | 2.83 |
| Total (%) | 100.00 |

The orange pomace filling is then combined with cereal based dough (50/50 ratio by weight) and then baked at 325° F. for 8 minutes.

Cereal Based Dough

| Ingredients | Formula (%) |
|---|---|
| Wheat flour, soft, unbleached | 35.27 |
| Dextrose (Glucose) | 1.91 |
| Molasses | 0.96 |
| Vanilla flavor | 0.12 |
| Salt | 0.51 |
| Baking Powder | 0.51 |
| Water | 14.00 |
| Sunflower Oil, high oleic | 13.73 |
| Invert Sugar syrup | 1.98 |
| Potassium sorbate | 0.25 |
| Oat flakes, old fashioned | 15.38 |
| Oat flakes, baby size | 15.38 |
| Total (%) | 100.00 |

The product is cut into orange pomace topped bars containing about 16% pomace and having water activity a_{w} of 0.75.

In further aspects, it was found that consumption of a predetermined amount of orange pomace combined with not-from-concentrate orange juice beverages resulted in metabolic and gut health benefits including reduced postprandial glucose without any statistically significant impact on insulin responses in humans, as well as an increased number of bowel movements. Results of clinical tests indicate that daily consumption of not-from-concentrate orange juice with at least 5 grams of fiber from enzymatically-treated pomace was sufficient to provide improved glucose control as compared to a baseline glucose level, and daily consumption of not-from-concentrate orange juice with 10 grams of fiber from enzymatically-treated pomace was sufficient to provide the additional benefit of more regular, frequent bowel movements as compared to a baseline bowel movement frequency. Further in vitro experiments found that not-from-concentrate orange juice containing orange pomace co-product made in accordance with the methods disclosed here resulted in increased gas production and short-chain fatty acid production when compared to a non-from-concentrate juice that does not include the co-product and compared to a whole orange.

According to certain embodiments, the type and amount of co-product is selected to be added to a juice to provide a finished beverage product that comprises an amount of nutrients which is similar to the amount of nutrients provided by the same fruit or vegetable when consumed whole. For instance, a whole peeled orange usually contains about 3 grams of fiber, whereas an eight-ounce glass of not-from-concentrate orange juice usually contains less than 1 gram of fiber. Thus, according to an embodiment of the invention, a juice beverage is prepared to include a fiber from enzymatically-treated pomace to provide a final beverage containing at least 3 grams of fiber.

An advantage of beverage products according to embodiments of the invention is that the products comprise the same or very close to the same level of nutrients as found in a whole fruit and/or vegetable, or even higher levels in the case of phytonutrients found in the whole fruit and/or vegetable but are less perishable due to the pasteurization process; in some cases the improved beverage products have a shelf life of weeks or months as opposed to days for some fresh fruit or vegetables. Additionally, beverages are convenient to consume without any further preparation required, e.g., peeling, cutting, cooking, etc.

### Example 8

The effects of fiber from enzymatically-treated pomace were tested using orange pomace treated with enzymes in accordance with embodiments discussed herein. For example, orange pomace was obtained from juice extraction and the inedible material, such as seeds, were removed. The orange pomace was treated by adding about 0.15-1 wt % of an enzyme mixture containing pectinase. The enzymatically-treated pomace was micronized/homogenized for consistency and then subjected to heat treatment to deactivate the enzymes.

Effects of fiber from enzymatically-treated pomace were tested using 10 healthy subjects aged 27.9±7.7 years, with a body mass index of 22.1±1.1 kgm⁻². The subjects participated in a randomized, 2-arm, cross-over clinical trial to test the glycemic response elicited by 252 grams of 100% orange juice (Control Sample) as compared to an approximately equal amount of 100% orange juice with 5 grams of fiber from enzymatically-treated pomace (Experimental Sample). Blood samples were collected, and glucose and insulin levels were measured at fasting (0 minutes) and then every 15 minutes for 2 hours after consumption of the Control Sample. The procedure was replicated for the Experimental Sample.

Analysis of the 2-hour incremental area under the curve (iAUC₀₋₂ₕ) indicated a significant reduction in blood glucose after ingesting the Experimental Sample (243.7±229.5 mg×min dL⁻¹) compared to the Control Sample (872.1±275.5 mg×min dL⁻¹ iAUC₀₋₂ₕ±SEM), p=0.02. Peak glucose concentrations were also lowered after consumption of the Experimental Sample as compared to the Control Sample (116.2±14.7 mg dL⁻¹ vs. 129.5±15.6 mg dL⁻¹, p<0.001, respectively). Further, no statistically significant difference was observed in insulin responses between the Experimental Sample and the Control Sample, respectively, as measured by iAUC (988.26±199.8 IU×min mL⁻¹ vs. 986.79±175.9 IU×min mL⁻¹, iAUC₀₋₂ₕ±SEM, p=0.9892) or peak insulin (Cₘₐₓ 26.9±13.5 μIU mL⁻¹ vs. 30.6±16.5 μIU mL⁻¹, p=0.202). Thus, the addition of 5 grams of fiber from orange pomace into a beverage attenuated the postprandial glucose response without impacting insulin.

These findings are significant, as serum glucose and insulin levels are directly linked to type II diabetes. In particular, large, rapid increased in blood glucose levels are signals to the beta-cells of the pancreas to increase insulin secretion. Over time, recurrent elevations in blood glucose and excessive insulin secretion are thought to increase the risk of developing type II diabetes as well as cardiovascular disease. Thus, a reduction in postprandial glucose and insulin response when compared to a control, whole oranges or not from concentrate orange juice alone may be beneficial to the consumer's health. Without being bound by theory, the inventors believe that because the processing methods described herein result in the fiber of the enzymatically-treated pomace as being more effectively soluble and thus potentially more bio accessible.

### Example 9

The effects of fiber from enzymatically-treated pomace were tested using orange pomace treated with enzymes in accordance with embodiments discussed herein. For example, orange pomace was obtained from juice extraction and the inedible material, such as seeds, were removed. The orange pomace was treated by adding about 0.15-1 wt % of an enzyme mixture containing pectinase. The enzymatically-treated pomace was micronized/homogenized for consistency and then subjected to heat treatment to deactivate the enzymes.

Effects of fiber from enzymatically-treated pomace were tested using 221 healthy subjects aged 23±0.5 years. The subjects participated in a randomized, double-blind, controlled trial, in which subjects received 16 ounces per day of a beverage containing 10 grams of fiber per day, which was derived from enzymatically-treated pomace (Experimental Sample). The subjects also received 16 ounces per day of a beverage lacking fiber derived from enzymatically-treated pomace (Control Sample). Subjects consumed the Experimental Sample or the Control sample for 21 days Surveys assessed frequency of bowel movements per week, Bristol stool score (BSS; weekly average of daily average scores), and Gastrointestinal Symptom Rating Scale scores. Automated Self-Administered 24-hour diet recalls were completed once per week during the intervention, and fiber was averaged per subject. Stool microbiota were analyzed by 16S rDNA sequencing and bifidobacteria (BIF) were quantified by qPCR.

Average dietary fiber (g/d) excluding pomace did not differ between groups (15.5±0.7 vs. 17.0±0.9, P=0.17). Including pomace, fiber intake was higher (26.4±0.9, P<0.0001). Mean weekly stool frequency was higher in the pomace fiber group (P=0.0281) and increased from baseline with pomace fiber (8.9±0.4 vs. 9.6±0.4 [LS mean+SEM], P=0.0003). This change was greater (P=0.0443) than the non-significant difference between baseline and intervention in the control group that consumed the Control Sample. Fiber from enzymatically-treated pomace resulted in softer stools per Bristol stool scoring during intervention versus control (3.8±0.1 vs. 3.6±0.1, P=0.0446). Indigestion syndrome scores were different due to participants reporting mild discomfort for symptoms of gas and bloating, confirming pomace fiber fermentation. Fiber from enzymatically treated pomace did not alter bifidobacteria, but did increase lachnospiraceae and ruminococcaceae. Sequencing showed no phylum-level bacterial changes.

The gas production is likely due to the increased fermentability of the fibers by the gut microbiota. The increased colonic fermentability of the fibers from enzymatically-treated pomace also resulted in increased production of short-chain fatty acids (SCFAs), including propionate, acetate, and butyrate. Without being bound by theory, it is believed that these SCFAs play a pivotal role in conferring health benefits to an individual such as protecting against colonic disorders and inhibiting the growth of pathogenic organisms.

### Additional Embodiments

The following descriptive embodiments are offered in further support of the disclosed invention:

In a first embodiment, novel aspects of the present disclosure are directed to a method for achieving a health benefit which comprises: consuming, within a 24-hour period, at least 5 grams of fiber from enzymatically-treated pomace to achieve the health benefit.

In another aspect of the first embodiment, the method for achieving a health benefit comprises: consuming, within a 24-hour period, at least 5 grams of fiber from enzymatically-treated pomace to achieve the health benefit, the method further comprising one or more limitations selected from the following list:

wherein the health benefit comprises at least one of a reduction of blood glucose levels as compared to a baseline blood glucose level and without a statistically significant increase in insulin level relative to a baseline insulin level;

wherein the method further comprises: consuming, within the 24-hour period, at least 10 grams of fiber from the enzymatically-treated pomace to achieve the health benefit, wherein the health benefit is an increased frequency of bowel movements;

wherein the method further comprises: consuming a first serving of a beverage comprising enzymatically-treated pomace, wherein the enzymatically-treated pomace provides the beverage with at least 5 grams of fiber per serving; and consuming a second serving of the beverage within 24 hours of the first serving to achieve the health benefit, wherein the health benefit comprises an increased frequency of bowel movements;

wherein each serving of the beverage is 8 fluid ounces;

wherein the consuming step(s) is/are repeated for at least seven consecutive days;

wherein the beverage comprises at least one deactivated enzyme in an amount between 0.3-1 wt % of the enzymatically-treated pomace;

wherein the amount of the at least one deactivated enzyme is between 0.15-0.75 wt % of the enzymatically-treated pomace;

wherein the at least one deactivated enzyme is selected from a group consisting of hemicellulase, cellulase, pectinase, and combinations thereof;

wherein the beverage further comprises juice selected from a group comprising orange, pineapple, apple, mango, cranberry, grapefruit, blueberry, acai, strawberry, grape, passion fruit, tomato, cucumber, kale, spinach, broccoli, carrot, lemons, limes, tangerine, mandarin orange, tangelo, pomelo, celery, beets, lettuce, spinach, cabbage, artichoke, broccoli, Brussels sprouts, cauliflower, watercress, peas, beans, lentils, asparagus, radish, peach, banana, pear, guava, apricot, watermelon, pomegranate, blackberry, papaya, lychee, plum, prune, fig and combinations thereof;

wherein the enzymatically-treated pomace is derived from at least one fruit or vegetable selected from the group comprising orange, pineapple, apple, mango, cranberry, grapefruit, blueberry, acai, strawberry, grape, passion fruit, tomato, lemon, lime, tangerine, mandarin orange, tangelo, pomelo, peach, banana, pear, guava, apricot, watermelon, pomegranate, blackberry, papaya, lychee, plum, prune, fig, cucumber, kale, spinach, broccoli, carrot, celery, beets, lettuce, spinach, cabbage, artichoke, coconut, broccoli, Brussels sprouts, cauliflower, watercress, peas, beans, lentils, asparagus, radish, wheat grass and combinations thereof; and

wherein the fiber in the enzymatically-treated pomace has a shorter chain length than native fiber in the pomace before the enzymatic treatment.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for achieving a health benefit comprising:
consuming, within a 24-hour period, at least 5 grams of fiber from enzymatically-treated pomace to achieve the health benefit.

2. The method of claim 1, wherein the health benefit comprises at least one of a reduction of blood glucose levels as compared to a baseline blood glucose level and without a statistically significant increase in insulin level relative to a baseline insulin level.

3. The method of claim 1, further comprising:
consuming, within the 24-hour period, at least 10 grams of fiber from the enzymatically-treated pomace to achieve the health benefit, wherein the health benefit is an increased frequency of bowel movements.

4. The method of claim 1, further comprising:
consuming a first serving of a beverage comprising enzymatically-treated pomace, wherein the enzymatically-treated pomace provides the beverage with at least 2.5 grams of fiber per serving; and
consuming a second serving of the beverage within 24 hours of the first serving to achieve the health benefit, wherein the health benefit is at least one of a reduction of blood glucose levels as compared to a baseline blood glucose level and without a statistically significant increase in insulin level relative to a baseline insulin level.

5. The method of claim 1, further comprising:
consuming a first serving of a beverage comprising enzymatically-treated pomace, wherein the enzymatically-treated pomace provides the beverage with at least 5 grams of fiber per serving; and
consuming a second serving of the beverage within 24 hours of the first serving to achieve the health benefit, wherein the health benefit is an increased frequency of bowel movements.

6. The method of claim 4 or 5, wherein each serving of the beverage is 8 fluid ounces.

7. The method of claim 1, wherein the beverage comprises at least 10 grams of fiber per serving, and wherein the health benefit further comprises more frequent bowel movements as compared to a baseline bowel movement frequency.

8. The method of claim 1, further comprising:
repeating the consuming step for at least seven consecutive days.

9. The method of claim 1, wherein the beverage comprises at least one deactivated enzyme in an amount between 0.3-1 wt % of the enzymatically-treated pomace.

10. The method of claim 9, wherein the amount of the at least one deactivated enzyme is between 0.15-0.75 wt % of the enzymatically-treated pomace.

11. The method of claim 9, wherein the at least one deactivated enzyme is selected from a group consisting of hemicellulase, cellulase, pectinase, and combinations thereof.

12. The method of claim 1, wherein the beverage further comprises juice selected from a group comprising orange, pineapple, apple, mango, cranberry, grapefruit, blueberry, acai, strawberry, grape, passion fruit, tomato, cucumber, kale, spinach, broccoli, carrot, lemons, limes, tangerine, mandarin orange, tangelo, pomelo, celery, beets, lettuce, spinach, cabbage, artichoke, broccoli, Brussels sprouts, cauliflower, watercress, peas, beans, lentils, asparagus, radish, peach, banana, pear, guava, apricot, watermelon, pomegranate, blackberry, papaya, lychee, plum, prune, fig and combinations thereof.

13. The method of claim 1, wherein the enzymatically-treated pomace is derived from at least one fruit or vegetable selected from the group comprising orange, pineapple, apple, mango, cranberry, grapefruit, blueberry, acai, strawberry, grape, passion fruit, tomato, lemon, lime, tangerine, mandarin orange, tangelo, pomelo, peach, banana, pear, guava, apricot, watermelon, pomegranate, blackberry, papaya, lychee, plum, prune, fig, cucumber, kale, spinach, broccoli, carrot, celery, beets, lettuce, spinach, cabbage, artichoke, coconut, broccoli, Brussels sprouts, cauliflower, watercress, peas, beans, lentils, asparagus, radish, wheat grass and combinations thereof.

14. The method of claim 1, wherein the fiber in the enzymatically-treated pomace has a shorter chain length than native fiber in the pomace before the enzymatic treatment.

15. The method of claim 1, further comprising:
consuming, within the 24-hour period, at least 10 grams of fiber from the enzymatically-treated pomace to achieve the health benefit, wherein the health benefit is softened stools.

16. The method of claim 1, further comprising:
consuming, within the 24-hour period, at least 10 grams of fiber from the enzymatically-treated pomace to achieve the health benefit, wherein the health benefit is increased colonic fermentation.
